(19) United States
(12) Patent Application Publication
(10) Pub. No.: US 2006/0052007 A1
(43) Pub. Date: Mar. 9, 2006

(54) Apparatus for inserting single spring

(76) Inventor: Sin-young Lee, Goyang-si (KR)

Correspondence Address: DILWORTH & BARRESE, LLP, 333 EARLE OVINGTON BLVD., UNIONDALE, NY, 11553, US

(21) Appl. No.: 11/222,012

(22) Filed: Sep. 8, 2005

(30) Foreign Application Priority Data
Sep. 8, 2004 (KR) 2004/25764

(51) Int. Cl. H01R 33/90

(52) U.S. Cl. 439/638

(57) ABSTRACT

The present invention discloses an apparatus for inserting a single spring in which the single spring is automatically inserted with a plurality of coupling holes formed on one side of a spring notebook irrespective of the size of the single spring and the thickness of the notebook and especially, a relatively short period of time for making the notebook is consumed, thereby attaining production in large quantities.

### BACKGROUND OF THE INVENTION

1. Field of the Invention

The present invention relates to an apparatus for inserting a single spring, and more particularly, to an apparatus for inserting a single spring in which the single spring is automatically inserted with a plurality of coupling holes formed on a notebook, thereby attaining the production in large quantities.

2. Background of the Related Art

Traditionally, all kinds of documents, notebooks, books, or calendars are bound in such a fashion that a sheet on which an adhesive is applied to one side thereof is bonded to another sheet to form a stack of sheets bonded at their one side thereof to one another. Otherwise, the stack of sheets is sewn by thread to bind them. In this case, it is found inevitably that a relatively long period of time for binding the plurality of sheets is consumed and also, the bound portion of them is covered by an additional strip or tape.

As a result, recently, a binding manner of employing a metal or synthetic resin spring is widely used in this field. That is, a plurality of coupling holes are formed on a notebook, a book, or a portion to be bounded, and then, a single spring or a double spring is inserted into the plurality of coupling holes, such that their sheets are bound by means of the single or double spring coupled in an arc shape with the coupling holes. The notebook that is manufactured in this manner is called a spring notebook. At this time, the notebook with the double spring is formed in such a manner that a pair of springs is inserted into each coupling hole and the respective arcs are opened on every coupling holes, thus making it easy to insert the double spring into the plurality of coupling holes. On the other hand, the notebook with the single spring is formed in such a manner that a single spring is inserted into each coupling hole and the respective arcs are closed and connected in a line, thus making it difficult to insert the single spring into the plurality of coupling holes.

In the case where a notebook with a single spring is made, conventionally, a plurality of coupling holes are firstly punched on the one side of the notebook, and next, the single spring is rotated by manually or semi-manually until it is all inserted into the plurality of coupling holes, thus making the time of making the notebook considerably delayed, which of course fails to accomplish the production in great quantities.

### SUMMARY OF THE INVENTION

Accordingly, the present invention has been made in view of the above-mentioned problems occurring in the prior art, and it is an object of the present invention to provide an apparatus for inserting a single spring in which a notebook is made in an automatic binding way irrespective of the size of the single spring and the thickness of the notebook and especially, a relatively short period of time for making the notebook is consumed, thus attaining the production in large quantities.

To accomplish the above object, according to the present invention, there is provided an apparatus for inserting a single spring into a plurality of coupling holes formed on a spring notebook, the apparatus including: first and second support plates for supporting and releasing the both sides of the spring notebook, each of the first and second support plates connected at the rear side thereof by means of a connecting rod to a cylinder moved along a moving rail, being closely contacted at the front surface thereof with each of the both side top portions of the spring notebook, and having a plurality of spring holes formed at the lower end thereof in such a manner as to protrude the single spring from the back thereof; a spring central side rotary bar axially coupled to the front ends of first axis support arms being slidably moved forwardly and backwardly by an advancing and retreating motor in such a manner as to conduct an upward and downward angular movement, having a plurality of first inducing grooves formed on the outer periphery thereof, the first inducing grooves being closely contacted with the single spring thus to rotate the single spring, and having a first timing gear formed at the one end thereof, the first timing gear having a first time belt mounted thereon and driven by a rotary motor, such that the spring central side rotary bar is placed at the downward side of the middle portion between the first and second support plates and at a binding process of the spring notebook, rotates the single spring along the first inducing grooves at the lower middle portion of the single spring thus to insert the single spring into the plurality of coupling holes; a spring front side rotary bar having a plurality of second inducing grooves formed on the outer periphery thereof and a second timing gear formed at the one end thereof, the second timing gear having a second time belt mounted thereon, such that the spring front side rotary bar is placed at the back side of the plurality of spring holes on the first support plate in such a manner as to conduct a forwardly angular movement with respect to a second axis thereof by means of second axis support arms and at a binding process of the spring notebook, rotates the single spring along the second inducing grooves at the front portion of the single spring thus to insert the single spring into the plurality of coupling holes; a spring front side rotary bar having a plurality of third inducing grooves formed on the outer periphery thereof and a third timing gear formed at the one end thereof, the third timing gear having a third time belt mounted thereon, such that the spring front side rotary bar is placed at the back side of the plurality of spring holes on the second support plate in such a manner as to conduct a backwardly angular movement with respect to a third axis thereof by means of third axis support arms and at a binding process of the spring notebook, rotates the single spring along the third inducing grooves at the rear portion of the single spring thus to insert the single spring into the plurality of coupling holes; and a notebook support stand placed at the lower ends of the first and second support plates at the front end thereof and axially fixed to a rotary shaft at the other end thereof, such that the notebook support stand supports the spring notebook at the downward sides of the first and second support plates and after insertion of the single spring with the plurality of coupling holes, drops down the spring notebook.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a side sectional view of showing an operation state of an apparatus for inserting a single spring according to the present invention;

FIG. 2 is a plan view of showing a state before operation of the apparatus of the present invention;

FIG. 3 is a front view of showing the enlarged principal parts in the apparatus of this invention;

FIG. 4 is a plan view of showing the structure of a spring central side rotary bar in the apparatus of this invention;

FIG. 5a is a side sectional view of showing the enlarged principal parts, at the state where a spring notebook is supported by a notebook support stand, in the apparatus of this invention;

FIG. 5b is a side sectional view of showing the enlarged principal parts, at the state where a spring notebook is moved downwardly by the notebook support stand, in the apparatus of this invention;

FIG. 6a is a side sectional view of showing the enlarged principal parts, at the state of operations of the spring central side rotary bar and the spring front/front side rotary bars, in the apparatus of this invention;

FIG. 6b is a side sectional view of showing the enlarged principal parts, at the state after the operations of the spring central side rotary bar and the spring front/front side rotary bars, in the apparatus of this invention;

FIG. 7 is an enlarged view of showing the principal parts of a conical spacer in the apparatus of this invention; and

FIG. 8 is an enlarged view of showing the principal parts of clearance-adjusting wedge members in the apparatus of this invention.

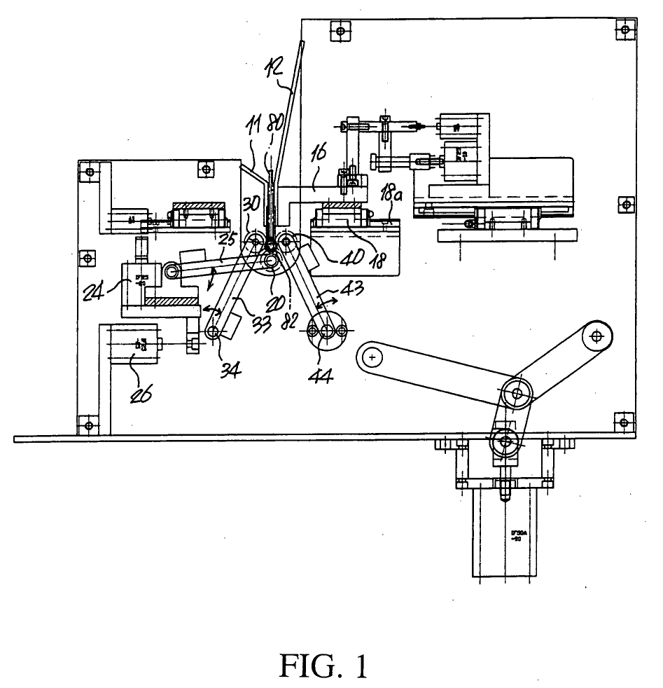

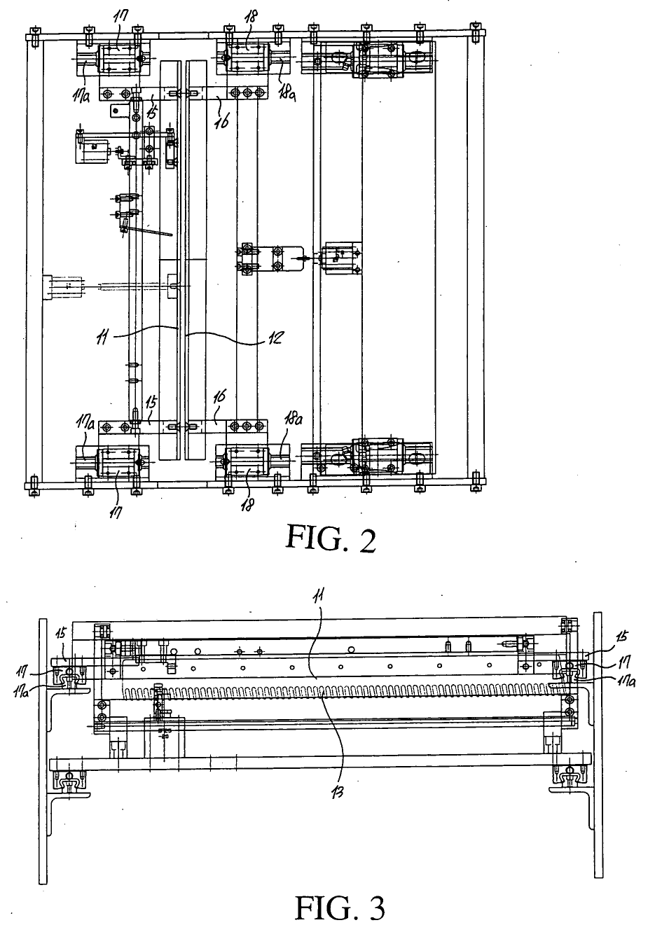

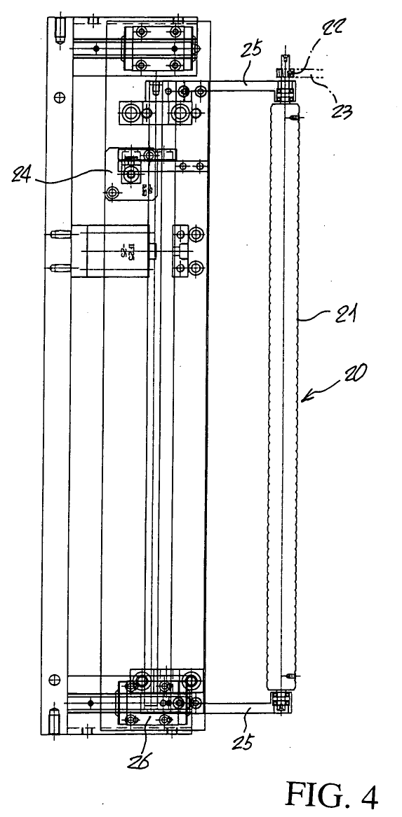

### DETAILED DESCRIPTION OF THE PREFERRED EMBODIMENT

Reference will now be made in detail to the preferred embodiments of the present invention, examples of which are illustrated in the accompanying drawings.

According to the present invention, there is provided an apparatus for inserting a single spring 82 into a plurality of coupling holes 81 formed on the one side of a spring notebook 80. A notebook support stand 50 supports the spring notebook 80 that is disposed in such a manner that the plurality of coupling holes 81 are placed downwardly at the lower side of the spring notebook 80, and first and second support plates 11 and 12 are closely contacted with the both sides of the spring notebook 80 fixedly placed by the notebook support stand 50. Furthermore, a spring central side rotary bar 20 is closely contacted with the lower middle portion of the single spring 82 thus to conduct the insertion of the single spring 82 into the plurality of coupling holes 81 of the spring notebook 80, a spring front side rotary bar 30 is closely contacted with the front middle portion of the single spring 82 thus to supportably rotate the single spring 82, and a spring front side rotary bar 40 is closely contacted with the rear middle portion of the single spring 82 to supportably rotate the single spring 82. Moreover, a conical spacer 60 is adapted to adjust the intervals between the spring central side rotary bar 20 and the spring front side rotary bar 30 and between the spring central side rotary bar 20 and the spring front side rotary bar 40, and clearance-adjusting wedge members 70 are adapted to adjust the clearance between the first and second support plates 11 and 12.

The first and second support plates 11 and 12 are closely contacted with the upper portions of the both sides of the spring notebook 80 on the front sides thereof to support and release the both sides of the spring notebook 80, having cylinders 17 and 18 moved along moving rails 17a and 18a at the rear sides thereof, connecting rods 15 and 16 connected to the cylinders 17 and 17, and a plurality of toothed spring holes 13 and 14 formed at the lower ends thereof so as to allow the single spring 82 to pass therethrough to be protruded from the back surface of the support plates.

The spring central side rotary bar 20 is disposed at the downward side of the middle portion between the first and second support plates 11 and 12 and at a binding process of the spring notebook 80, rotates the single spring 82 along a plurality of first inducing grooves 21 as will be discussed below at the lower middle portion of the single spring 82 thus to insert the single spring 82 into the plurality of coupling holes 81, having axis support arms axially coupled to the front ends thereof so as to conduct upward and downward angular movements and slidably moved forwardly and backwardly by an advancing and retreating motor 26, the plurality of first inducing grooves 21 formed on the outer periphery thereof, the first inducing grooves along which the single spring 82 is rotated thus to guide the single spring 82 to the plurality of coupling holes 81, and a first timing gear 22 formed at the one end thereof, the first timing gear 22 having a first time belt 23 mounted thereon and driven by a rotary motor 24.

The spring front side rotary bar 30 rotates, at a binding process of the spring notebook 80, the single spring 82 along a plurality of second inducing grooves 31 as will be discussed below at the front side of the single spring 82 thus to insert the single spring 82 into the plurality of coupling holes 81, having the plurality of second inducing grooves 31 formed on the outer periphery thereof, a second timing gear 32 formed at the one end thereof, the second timing gear 32 having a second time belt 23 mounted thereon, and axis support arms 33 axially coupled to the front ends thereof in such a manner as to be placed at the back side of the plurality of spring holes 13 on the first support plate 11, conducting a forwardly angular movement with respect to a second axis 34 thereof.

The spring front side rotary bar 40 rotates, at a binding process of the spring notebook 80, the single spring 82 along a plurality of third inducing grooves 41 as will be discussed below at the rear side of the single spring 82 thus to insert the single spring 82 into the plurality of coupling holes 81, having the plurality of third inducing grooves 41 formed on the outer periphery thereof, a third timing gear 42 formed at the one end thereof, the third timing gear 42 having a third time belt 43 mounted thereon, and axis support arms 44 axially coupled to the front ends thereof in such a manner as to be placed at the back side of the plurality of spring holes 14 on the second support plate 12, conducting a forwardly angular movement with respect to a third axis 44 thereof.

The notebook support stand 50 has a shaped structure in such a manner as to support the spring notebook 80 at the downward sides of the first and second support plates 11 and 12 and after insertion of the single spring 82 with the plurality of coupling holes 81, drop down the spring notebook 80, having the front end adapted to support the spring notebook 80 at the downward sides of the first and second support plates 11 and 12 and the other end fixed to a rotary shaft 51.

The conical spacer 60 is a short bar that is conical at the one end thereof, and is placed at the front ends of the spring central side rotary bar 20 and the spring front/front side rotary bars 30 and 40. Thus, the conical spacer 60 moves inwardly from the central point among the spring central side rotary bar 20 and the spring front/front side rotary bars 30 and 40, with a result that the intervals between the spring central side rotary bar 20 and the spring front side rotary bar 30 and between the spring central side rotary bar 20 and the spring front side rotary bar 40 are adjusted according to the size of the diameter of the single spring 82 to be inserted into the spring notebook 80.

The clearance-adjusting wedge members 70 each have a generally sharp front tip and moves from the front ends of the first and second support plates 11 and 12 to the inside between the first and second support plates 11 and 12, with a result that the clearance between the first and second support plates 11 and 12 is adjusted according to the thickness of the spring notebook 80.

Now, an explanation on the operation of the apparatus for inserting the single spring according to the present invention will be given below.

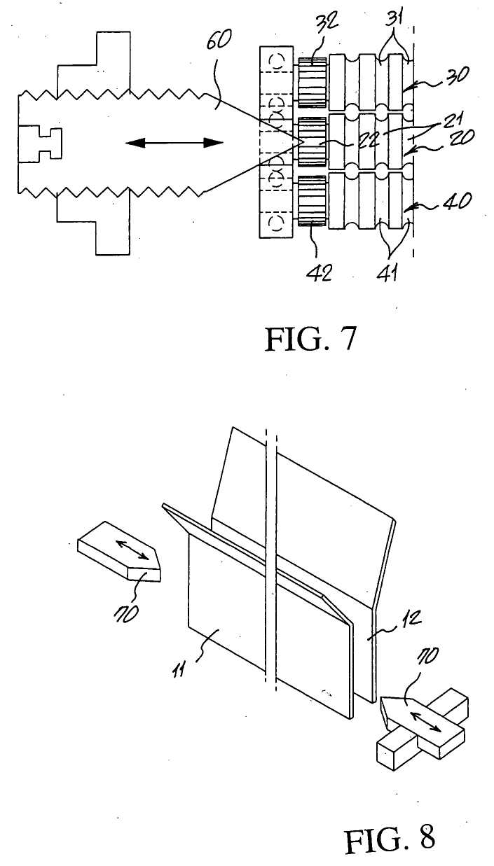

As shown in FIG. 7, according to the size of the single notebook 82 to be inserted into the spring notebook 80, first, the conical spacer 60 slowly moves toward the central side of the front ends of the spring central side rotary bar 20 and the spring front/front side rotary bars 30 and 40 and adjusts the intervals between the spring central side rotary bar 20 and the spring front side rotary bar 30 and between the spring central side rotary bar 20 and the spring front side rotary bar 40. After that, the intervals are fixedly set at the process of insertion of the single spring 82.

As shown in FIG. 8, according to the thickness of the spring notebook 80 to be put between the first and second support plates 11 and 12, next, the clearance-adjusting wedge members 70 slowly move from the both front ends of the first and second support plates 11 and 12 to the inside between the first and second support plates 11 and 12 to adjust the clearance between the first and second support plates 11 and 12. After that, the clearance is fixedly set at the process of insertion of the single spring 82.

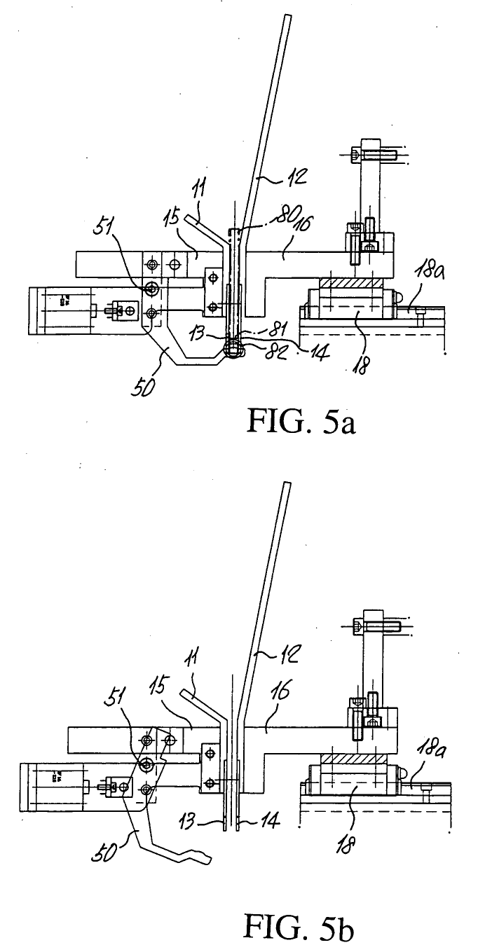

After the preparation for the binding process has been finished, the spring notebook 80 having the plurality of coupling holes 81 formed at the one end thereof is put between the first and second support plates 11 and 12, and as a result, as shown in FIG. 5a, the bottom face of the spring notebook 80 is supported by the notebook support stand 50 and as the cylinders 17 and 18 connected by the connection rods 15 and 16 are moved along the moving rails 17a and 18b, the first and second support plates 11 and 12 come in close contact with the spring notebook 80 at the left and right sides with respect to the spring notebook 80, with a result of permitting the spring notebook 80 to be fixedly disposed between the first and second support plates 11 and 12.

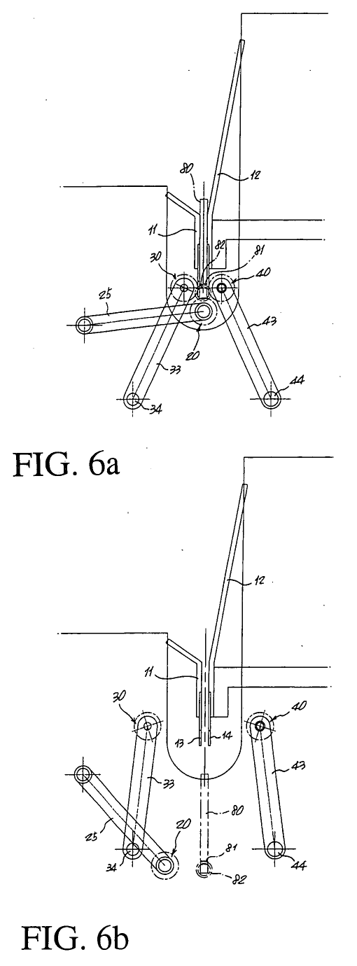

In this case, as shown in FIG. 6a, if the single spring 82 is placed at the inside among the spring central side rotary bar 20 and the spring front/front side rotary bars 30 and 40, the single spring 82 is rotated along the first to third inducing grooves 21, 31 and 41 of the spring central side rotary bar 20 and the spring front/front side rotary bars 30 and 40, such that the front end of the single spring 82 starts to be guided to the plurality of coupling holes 81 and as the spring central side rotary bar 20 and the spring front/front side rotary bars 30 and 40 are kept rotated, the single spring 82 is inserted into the plurality of coupling holes 81 of the spring notebook 80.

At this time, the single spring 82 is protruded toward the left and right sides through the spring holes 13 and 14 formed at the lower ends of the first and second support plates 11 and 12, and the protruded left and right sides of the single spring 82 are closely contacted with the second and third inducing grooves 31 and 41 of the front and rear rotary bars 30 and 40, thereby rotating the single spring 82 to insert the single spring 82 into the plurality of coupling holes 81.

When the single spring 82 is inserted into the plurality of coupling holes 81 of the spring notebook 80, the spring central side rotary bar 20 and the spring front/front side rotary bars 30 and 40 that are closely rotated at the bottom end and the left/right side ends of the single spring 82 are returned to their original place by means of the axis support arms 25, 33, and 43 and thus separated from the single spring 82, as shown in FIG. 6b. Next, as shown in FIG. 5b, the notebook support stand 50 is rotated with respect to the rotary shaft 51, and the first and second support plates 11 and 12 are returned to their original place by means of the connection rods 15 and 16 connected to the cylinders 17 and 18. As a result, the spring notebook 80 after the insertion is dropped down.

As set forth in the foregoing, there is provided the apparatus for inserting the single spring according to the present invention in which before the insertion process, appropriate intervals and clearance are previously set by an operator according to the size of the single spring and the thickness of the spring notebook, and especially, a relatively short period of time for inserting the single spring into the plurality of coupling holes is consumed, thus attaining the production in large quantities.

Of course, the apparatus of this invention is not applied only to the spring notebook, but it is applicable to all kinds of books, pamphlets, calendars, and so on. While the present invention has been described with reference to the particular illustrative embodiments, it is not to be restricted by the embodiments but only by the appended claims, and therefore, it is to be understood that other modifications and variations may be made without departing from the substance and scope of the present invention, as those skilled in the art will readily understand. Such alternate modifications and variations are within the scope of the present invention which is intended to be limited only by the appended claims and equivalents thereof.

What is claimed is:

1. An apparatus for inserting a single spring into a plurality of coupling holes on a spring notebook, the apparatus comprising:
first and second support plates for supporting and releasing both sides of the notebook;
a spring central side rotary bar placed at a downward side of a middle portion between the first and second support plates and rotating the single spring along first inducing grooves at a lower middle portion of the spring to insert into the plurality of coupling holes;
a first spring front side rotary bar rotating the single spring along second inducing grooves at a front portion of the spring;
a second spring front side rotary bar rotating the single spring along a third inducing grooves at a rear portion of the spring; and
a notebook support stand supporting the notebook at downward sides of the first and second support plates and after insertion of the single spring, which drops down the spring notebook.

2. The apparatus as set forth in claim 1, further comprising a conical spacer placed at front ends of the spring central side rotary bar and the first and second spring front side rotary bars, moving inwardly from a central point among the spring central side rotary bar and the spring front side rotary bars, such that the intervals between the spring central side rotary bar and the spring front side rotary bars and between the spring central side rotary bar and a rear side rotary bar are adjusted according to a diameter of the single spring.

3. The apparatus as set forth in claim 1, further comprising a pair of clearance-adjusting wedge members each having a front tip and moving from front ends of the first and second support plates to the inside between the first and second support plates, such that the clearance between the first and second support plates is adjusted according to a thickness of the spring notebook.

4. An apparatus for inserting a single spring into a plurality of coupling holes on a spring notebook, the apparatus comprising:
first and second support plates for supporting and releasing both sides of the spring notebook, each of the first and second support plates connected at a rear side thereof by a connecting rod to a cylinder moved along a moving rail, being closely contacted at a front surface thereof with each of the both side top portions of the spring notebook, and having a plurality of spring holes formed at a lower end thereof for allowing the single spring to pass therethrough to protrude from a back surface thereof;
a spring central side rotary bar axially coupled to front ends of first axis support arms being slidably moved forwardly and backwardly by an advancing and retreating a motor to conduct an upward and downward angular movement, having a plurality of first inducing grooves formed on an outer periphery thereof, the first inducing grooves being closely contacted with the single spring to rotate the single spring, and having a first timing gear formed at one end thereof, the first timing gear having a first time belt mounted thereon and driven by a rotary motor, such that the spring central side rotary bar is placed at a downward side of a middle portion between the first and second support plates, and during a binding process of the spring notebook, rotates the single spring along the first inducing grooves at the lower middle portion of the single spring thus to insert the single spring into the plurality of coupling holes;
a first spring front side rotary bar having a plurality of second inducing grooves formed on an outer periphery thereof and a second timing gear formed at the one end thereof, the second timing gear having a second time belt mounted thereon, such that the first spring front side rotary bar is placed at a back side of the plurality of spring holes on the first support plate to conduct a forwardly angular movement with respect to a second axis thereof by second axis support arms, and during a binding process of the spring notebook, rotates the single spring along the second inducing grooves at the front portion of the single spring to insert the single spring into the plurality of coupling holes;
a second spring front side rotary bar having a plurality of third inducing grooves formed on an outer periphery thereof and a third timing gear formed at the one end thereof, the third timing gear having a third time belt mounted thereon, such that the second spring front side rotary bar is placed at a back side of the plurality of spring holes on the second support plate to conduct a backwardly angular movement with respect to a third axis thereof by third axis support arms, and during a binding process of the spring notebook, rotates the single spring along the third inducing grooves at a rear portion of the single spring to insert the single spring into the plurality of coupling holes; and
a notebook support stand placed at lower ends of the first and second support plates at a front end thereof and axially fixed to a rotary shaft at the other end thereof, such that the notebook support stand supports the spring notebook at the downward sides of the first and second support plates and after insertion of the single spring with the plurality of coupling holes, drops down the spring notebook.
